(19) United States
(12) Patent Application Publication
(10) Pub. No.: US 2015/0304778 A1
(43) Pub. Date: Oct. 22, 2015

(54) Loudspeaker Transducer with Flexible Coupler Between Cone and Voice Coil

(71) Applicant: Harman International Industries, Inc., Stamford, CT (US)

(72) Inventor: Jerry Moro, Moorpark, CA (US)

(21) Appl. No.: 14/610,354

(22) Filed: Jan. 30, 2015

Related U.S. Application Data
(60) Provisional application No. 61/933,376, filed on Jan. 30, 2014.

(51) Int. Cl. H04R 9/02; H04R 1/00; H04R 9/06

(52) U.S. Cl. CPC H04R 9/02; H04R 9/06; H04R 1/00

(57) ABSTRACT

A loudspeaker transducer includes a voice coil former and a trough member attached to the voice coil former, where the trough member includes a flexible adhesive material therein. A cone is received within the trough member and secured therein by the flexible adhesive material to provide a flexible coupling between the voice coil former and the cone. In other embodiments, the cone may be received by a flexible insert member or secured between flexible disks to provide a flexible coupling of the cone and voice coil former.

### CROSS-REFERENCE TO RELATED APPLICATIONS

This application claims the benefit of U.S. provisional application Ser. No. 61/933,376 filed Jan. 30, 2014, the disclosure of which is hereby incorporated in its entirety by reference herein.

### TECHNICAL FIELD

Embodiments relate to loudspeaker transducers with flexible couplers between the cone and the voice coil.

### BACKGROUND

Powered subwoofers, or even passive subwoofers with external amplification, use different types of amplifier topologies which all employ various methods of high power protection and limiters or compressors to improve sound quality during the onset of amplifier clipping or overload. Amplifier clipping generates additional high frequency artifacts that contaminate the harmonic structure of the original music signal. Limiters and compressors are used to suppress the amplifier output so that the amplifier stays within its voltage limits. When these voltage limits are exceeded, limiters and compressors work to soften the harsh clipping artifacts so that the natural sinusoidal waveform can be restored. Unfortunately, limiters and compressors are not perfect and still allow high frequency noises and distortion to escape and ride on the original signal. This can be manifested as high frequency noise on the peaks of the musical waveform or as grossly distorted non-sinusoidal waveforms.

These high frequency noise artifacts or distortions are delivered directly to the low frequency transducer, which is typically connected to the amplifier outputs without passive filtration. In this situation, all of the high frequency distortion is passed onto the transducer and then radiated acoustically into the environment. Active filtration, in typical pre-amplification stages, will have no effect on reducing these clipping distortions from reaching the low frequency transducer. The level of audibility of this distortion depends greatly on the high frequency output response of the transducer. If the transducer has an extended upper response and/or a large peak in the upper frequencies, then any clipping distortions or limiter/compressor noise artifacts will be greatly amplified and easily heard.

Limiters/compressors have improved over the years and can be adjusted to virtually eliminate clipping noise artifacts. To accomplish this, however, limiter/compressor setting thresholds must be set very aggressively to react almost prematurely to the musical signal peaks. The biggest issue is tracking the duty cycle of the musical signal and properly setting the attack and release threshold rates. Even when properly adjusted, the limiter can still limit the dynamics of the original signal, thus taking the life (realism) out of the sound. Moreover, this still does not guarantee that the limiter/compressor will suppress all clipping noise artifacts, as some may still get through to the transducer.

One current solution to reduce this high frequency output is post-amplification passive filtering between the amplifier output stage and transducer. This would typically be in the form of an RC, LC or RLC passive network. This type of filter may need to handle high power, so the packaging size and cost of additional components is an issue. Another solution is using transducers with a very high inductive load. This is typically done with the motor coil system by using a voice coil with many turns (windings and layers), and placing this coil around a large steel core (the transducer motor's pole piece). This will greatly increase inductance which will help reduce high frequency output. However, it is typically still not enough reduction of high frequency output, and can result in other issues like increased voice coil cost and less acoustic output since the high inductance (high-turn) voice coil is now much heavier. Also, some amplifiers have issues driving highly inductive transducer loads, which leads to additional distortions that the limiter/compressor must now control.

### SUMMARY

In one embodiment, a loudspeaker transducer comprises a voice coil former, and a trough member attached to the voice coil former and including a flexible adhesive material therein. A cone is received within the trough member and secured therein by the flexible adhesive material to provide a flexible coupling between the voice coil former and the cone.

In another embodiment, a loudspeaker transducer comprises a voice coil former and a flexible insert member attached to the voice coil former. A cone is received by the insert member to provide a flexible coupling between the voice coil former and the cone.

In another embodiment, a loudspeaker transducer comprises a voice coil former and an insert member attached to the voice coil former. The loudspeaker transducer further includes an upper ring and a lower ring each engaging the insert member, and a cone received between the upper and lower rings. Flexible disks are disposed on either side of the cone adjacent the upper and lower rings, wherein the upper and lower rings secure the cone between the disks to provide a flexible coupling between the voice coil former and the cone.

### BRIEF DESCRIPTION OF THE DRAWINGS

FIG. 1 is a partial cross-sectional view of a loudspeaker transducer with a flexible adhesive material and trough member according to an embodiment;

FIG. 2 is a partial cross-sectional view of a loudspeaker transducer with a flexible adhesive material and trough member according to another embodiment;

FIG. 3 is a partial cross-sectional view of a loudspeaker transducer with a flexible adhesive material and trough member according to another embodiment;

FIG. 4 is a partial cross-sectional view of a loudspeaker transducer with a flexible adhesive material and troughed spider according to an embodiment;

FIG. 5 is a partial cross-sectional view of a loudspeaker transducer with a flexible insert member according to an embodiment;

FIG. 6 is a cross-sectional view of a loudspeaker transducer with a flexible insert member and flexible adhesive material according to an embodiment;

FIG. 7 is a cross-sectional view of a loudspeaker transducer with a flexible coupling combined with mechanical clamps according to an embodiment; and

FIG. 8 is a cross-sectional view of a loudspeaker transducer according to an embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of a loudspeaker transducer having a flexible, soft coupler are disclosed herein for mechanically decoupling the transducer's acoustic radiating surface (diaphragm or cone or cone/dome assembly) from the drive voice coil, with the goal being greatly reduced high frequency output and minimized clipping noise artifacts from being audible. In a sense, the flexible coupler can be considered a low-pass mechanical filter, starting at frequencies sufficiently above the operational bandwidth to encompass the frequency range where clipping noise artifacts are possible. The intent is to allow a transducer to only pass low frequency acoustic signals without alteration and without the aid of additional passive or electronic components.

This mechanical decoupling can be achieved by several different embodiments which are shown and described herein. The flexible coupler secures the radiating area (such as at the transducer cone neck or diaphragm joint) by an adhesive material or other material of low durometer (hardness) and viscoelastic damping property so that high frequency energy originated by the drive voice coil is sufficiently dissipated. This secured joint between the voice coil and cone/diaphragm can be viewed as an additional compliance (due to the non-rigid coupling), where at a specific upper frequency range the drive voice coil and upper radiating cone or diaphragm will start to decouple from each other. As a result, higher frequency energy will not be passed from the voice coil to the cone/diaphragm, thus reducing the audibility of the clipping created by the amplifier.

The flexible couplers disclosed herein are designed such that they are stiff enough to offer tight control at low frequencies, typically DC to several hundred Hertz. Therefore, the musical signal is not affected in the low frequency operational bandwidth of the system. Also, the flexible couplers may be optimized to not allow instabilities when subjected to high displacement loads. In this case, these instabilities would cause conditions of voice coil rubs, fatigue failures, and higher distortion due to unnecessary flexing of the coupler at operational bandwidth frequencies. Furthermore, the flexible couplers may be robust enough to maintain a reliable connection between the radiating surfaces and the drive voice coil even when subjected to high temperatures and axial forces generated by the voice coil. It is contemplated that durometer values below about 80 or 90 (measured in the Shore A scale) may be utilized for the flexible components described herein to provide sufficient high frequency decoupling. In order to maintain stability in the operational bandwidth, the exact durometer value required may be optimized for the specific cone or diaphragm geometry being used and the power handling requirement.

In the disclosed embodiments, one application of the flexible coupler is for transducers (woofers) used in subwoofer systems that are either internally or externally powered with a typical operational bandwidth of DC to several hundred Hertz, however other applications may be also be possible.

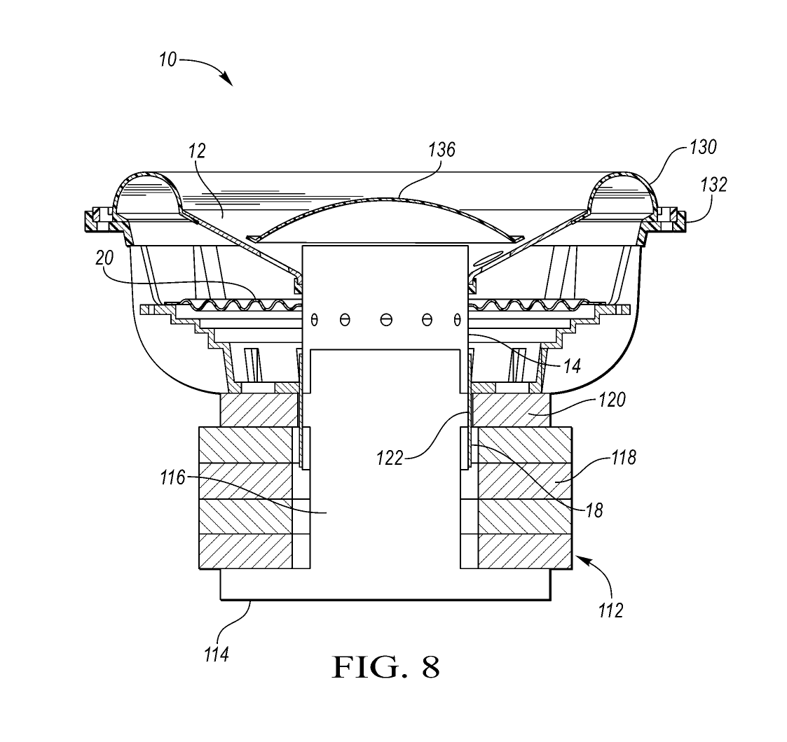

With reference first to the cross-sectional view of FIG. 8, a loudspeaker transducer 10 may include a motor assembly 112 having a back plate 114 and a pole piece 116 centrally disposed with respect to the back plate 114, a permanent magnet 118, and a front or top plate 120 concentrically disposed with respect to the pole piece 116, wherein the motor assembly 112 may provide a substantially uniform magnetic field across an air gap 122. A voice coil former 14 may support a voice coil 18 in the air gap 122. The loudspeaker 10 may also include a diaphragm or cone 12, wherein a portion of the cone 12 may be coupled with an end of the voice coil former 14. An outer end of the cone 12 may be coupled to a surround 130 which, in turn, may be coupled at an outer perimeter to a frame or basket 132. A spider 20 may be coupled to the basket 132 and may include a central opening to which the voice coil former 14 is coupled. In other examples, the cone 12 may be coupled with the voice coil former 14 via the spider 20 or any other component of the loudspeaker transducer 10. In addition, the loudspeaker transducer 10 may include a center cap or dust dome 136 that is designed to keep dust or other particulars out of the motor assembly 112.

As is known in the art, the loudspeaker transducer 10 may be mounted within an enclosure (not shown), and a loudspeaker system may also include additional internal components within the enclosure such as, but not limited to, an amplifier (not shown). During operation, current from the amplifier or some other device supplying electrical signals representing program material to be transduced by the loudspeaker 10 may drive the voice coil 18. Axial reciprocation of the voice coil 18 in the air gap 122 in connection with the cone 12 generates sound representing the program material transduced by the loudspeaker transducer 10. Other speaker components may alternatively or additionally be included in the loudspeaker system.

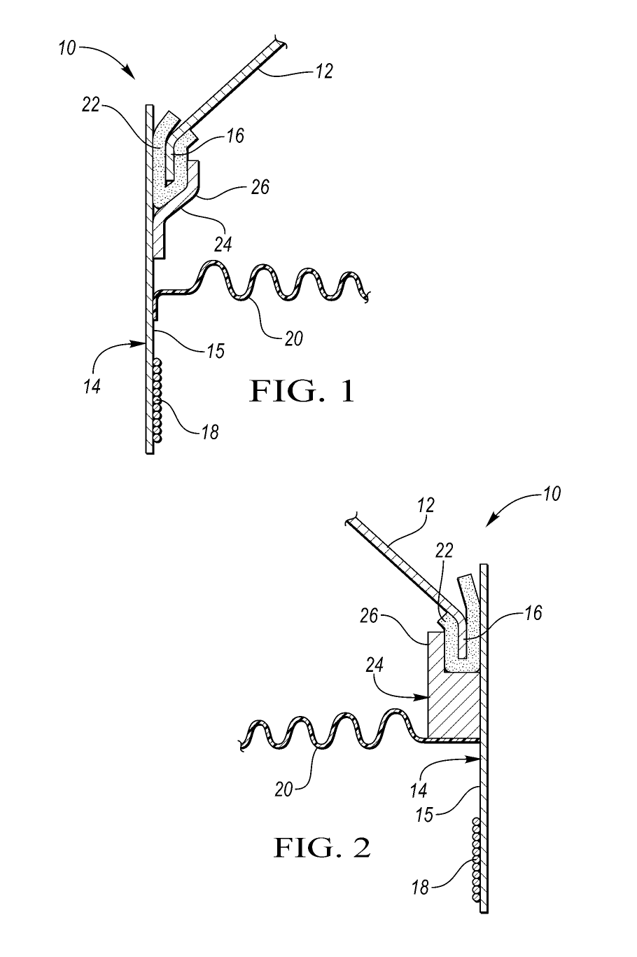

Turning now to FIG. 1, a partial cross-sectional view of a loudspeaker transducer 10 is illustrated. The transducer 10 includes a diaphragm or cone 12, wherein the cone 12 may have a downwardly depending neck portion 16. The transducer 10 further includes a voice coil former 14 having a voice coil 18, and a spider 20 attached to the voice coil former 14. In this embodiment, a flexible coupler comprising a low durometer (i.e., below about 90 Shore A), flexible adhesive material 22 such as, but not limited to, silicone may be disposed adjacent the cone 12, more specifically the neck region 16, to adhere to and flexibly couple the cone 12 to the voice coil former 14. A trough member 24 may be attached to the voice coil former 14, such as at an exterior surface 15 thereof, or constructed integrally with the voice coil former 14 to receive the neck portion 16 and contain the adhesive material 22 within the cone neck portion 16 area. The trough member 24 may have any suitable shape for the intended purpose, such as including a lip portion 26. The trough member 24 may also be constructed from any suitable material such as, but not limited to, plastic, or of a material similar to that of which the voice coil former 14 is constructed.

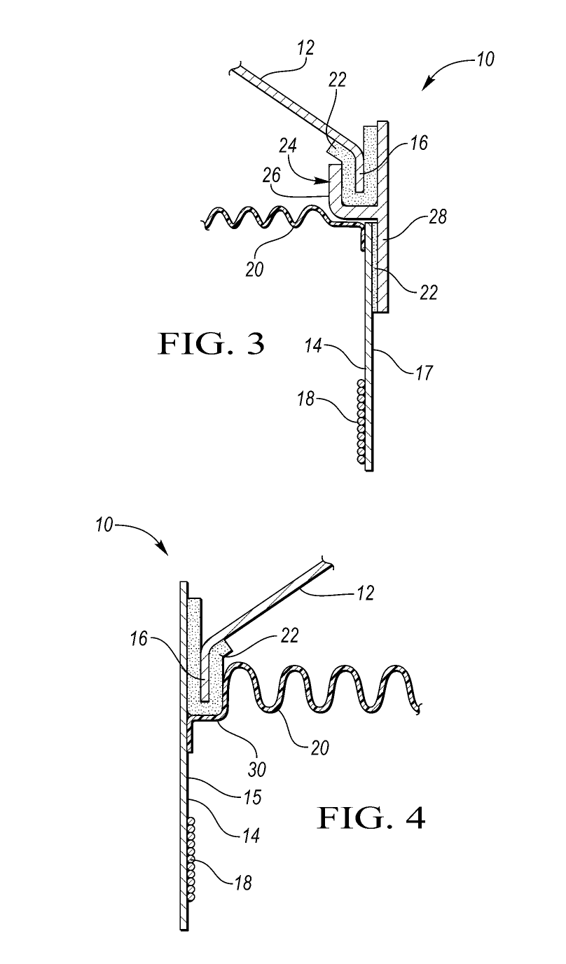

FIG. 2 illustrates another embodiment of a transducer 10 with a flexible, decoupling adhesive material 22 between the cone 12 and the voice coil former 14. In this embodiment, the trough member 24 may be attached to the voice coil former 14 and may have a tube shape as shown. In one example, the trough member 24 may be constructed from a material such as laminated cardboard. In the embodiment of FIG. 3, the trough member 24 may have a downwardly extending flange 28 arranged to be affixed to an interior surface 17 of the voice coil former 14, wherein the flexible adhesive material 22 may be used in this area as well as adjacent the cone neck region 16 to secure the trough member 24 to the voice coil former 14 and provide flexible coupling and high frequency filtering. In this embodiment, the trough member 24 extends upwardly beyond the voice coil former 14, and may be constructed from a molded plastic material, for example. Of course, other configurations and materials of the trough member 24 are also contemplated.

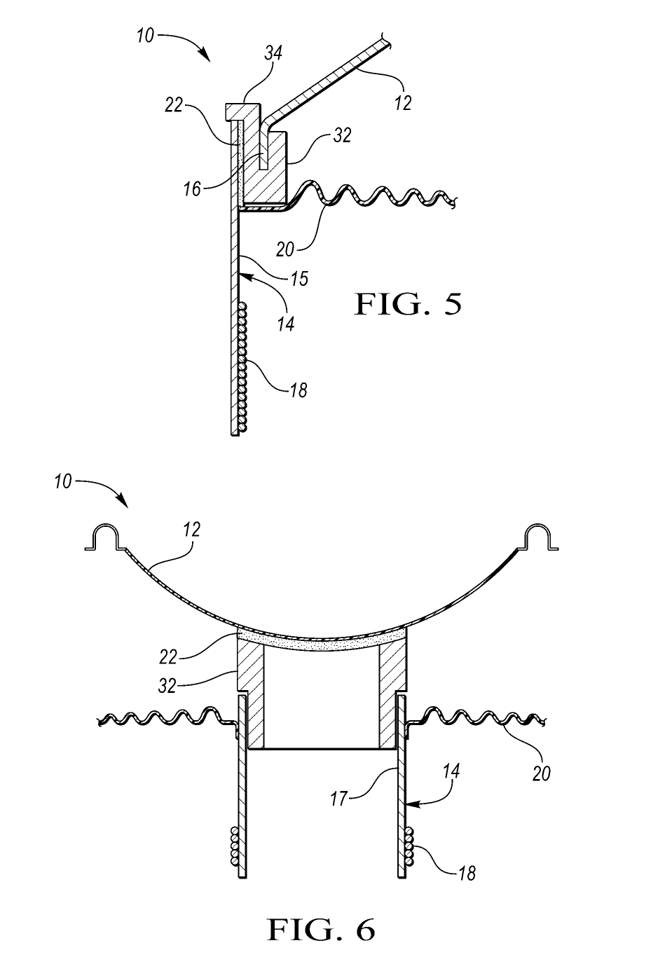

Turning now to FIG. 4, another flexible coupling arrangement is illustrated which employs a spider 20, where the trough member comprises a portion 30 of the spider 20 adjacent the voice coil former 14 which is configured to contain the flexible adhesive material 22. In the embodiment of FIG. 5, a flexible coupler comprises a flexible insert member 32 constructed from a low durometer material (i.e., below about 90 Shore A), such as rubber, which is configured to receive the cone 12, such as at the neck portion 16. The insert member 32 is attached to the voice coil former 14, such as on the exterior surface 15 thereof, to provide a flexible coupling between the cone 12 and the voice coil former 14. The insert member 32 may be affixed to the cone neck portion 16, such as with glue or another adhesive, or alternatively may be insert-molded (co-molded) to the cone neck portion 16. The insert member 32 may be attached to the voice coil former 14 by adhesive material 22, and may extend beyond the voice coil former 14. In one embodiment, the insert member 32 includes a flange 34 that is supported on an upper edge of the voice coil former 14 as shown, although it is understood that the insert member 32 is not limited to this configuration.

FIG. 6 illustrates a loudspeaker transducer 10 wherein the flexible coupler between the cone 12 and the voice coil former 14 may comprise both a flexible adhesive material 22 and a flexible insert member 32. For example, the insert member 32 may be affixed to the voice coil former 14, such as at the interior surface 17 thereof, and the adhesive material 22 may secure the insert member 32 to the cone 12. It is understood that this is only one example of a flexible coupling that combines both an adhesive material component and another low durometer material component, and that other configurations are fully contemplated.

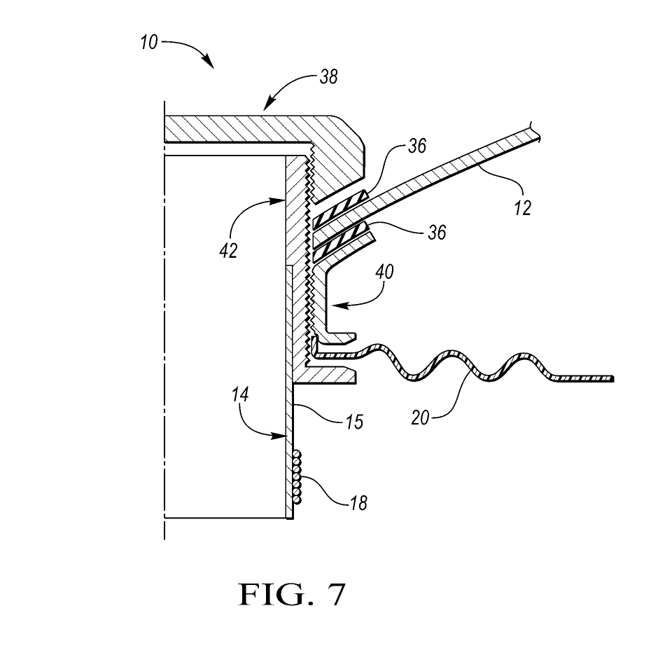

FIG. 7 illustrates a loudspeaker transducer 10 wherein the flexible coupler between the cone 12 and the voice coil former 14 comprises low durometer (i.e., below about 90 Shore A) disks 36 constructed from, for example, but not limited to, rubber which hold the cone 12 in place by way of mechanical clamping from upper 38 and lower 40 rings. An insert member 42 is attached to the voice coil former 14, either mechanically or by adhesive, and the upper and lower rings 38, 40 engage the insert member 42. The cone 12 is received between the upper and lower rings 38, 40, and the flexible disks 36 are disposed on either side of the cone 12 adjacent the upper and lower rings 38, 40, such that the upper and lower rings 38, 40 secure the cone 12 between the disks 36 to provide a flexible coupling between the voice coil former 14 and the cone 12. In one embodiment, the insert member 42, the upper ring 38, and the lower ring 40 are each threaded, and rotation of the upper ring 38 and the lower ring 40 toward one another about the insert member 42 clamps the cone 12 between the upper and lower rings 38, 40. The lower ring 40 may also mechanically clamp the spider 20 into position, securing it to the voice coil former 14. This embodiment allows for the assembly of the cone 12, spider 20, voice coil 14 and flexible disks 36 without the use of adhesives. As such, any future repair effort is also simplified.

In the embodiments disclosed herein, the durometer of the flexible coupler (adhesive material or other low durometer, viscoelastic damping material) should allow the direct connection (voice coil to cone/diaphragm) to not encounter losses or frequency response issues at very low subwoofer frequencies (DC-200 Hz). Furthermore, in any of the above-described embodiments, to improve low frequency stability, the cone neck region 16 may be constructed to be of extended length compared with typical cone construction in order to facilitate flexible coupling of the cone 12 with the voice coil former 14 as disclosed herein.

Mechanically decoupling the radiating surface (cone/diaphragm) from the drive voice coil suppresses unwanted high frequency noises and distortion directly. This flexible coupling greatly reduces or eliminates transmission of high frequency energy being produced in the voice coil from reaching the radiating surface. When using a viscoelastic damping material, this unwanted high frequency energy will typically be transferred (converted) into heat. All that is passed is the intended low frequency signal, and no intermediate passive or electronic component filter is required.

Other benefits of the disclosed embodiments are that the limiter/compressor settings can now be relaxed and not be so restrictive. This will allow the system to respond better to transients and not limit dynamic output, thus utilizing more of the amplifier's maximum voltage potential. Depending on the amplifier topology used, it is entirely possible that applying the flexible coupler embodiments as described herein could eliminate the need for a limiter/compressor altogether for maximum acoustic output per amplifier watt.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A loudspeaker transducer comprising:
a voice coil former;
a trough member attached to the voice coil former and including a flexible adhesive material therein; and
a cone received within the trough member and secured therein by the flexible adhesive material to provide a flexible coupling between the voice coil former and the cone.

2. The loudspeaker transducer of claim 1, wherein the cone includes a neck portion which is received within the trough member.

3. The loudspeaker transducer of claim 1, wherein the flexible adhesive material is used to secure the trough member to the voice coil former.

4. The loudspeaker transducer of claim 1, wherein the trough member extends beyond the voice coil former.

5. The loudspeaker transducer of claim 1, wherein the trough member is attached to an exterior surface of the voice coil former.

6. The loudspeaker transducer of claim 1, wherein the trough member is attached to an interior surface of the voice coil former.

7. The loudspeaker of claim 1, wherein the flexible adhesive material has a durometer value below about 90 Shore A

8. The loudspeaker of claim 1, wherein the loudspeaker transducer further includes a spider attached to the voice coil former and the trough member comprises a portion of the spider adjacent to the voice coil former.

9. A loudspeaker transducer comprising:
a voice coil former;
a flexible insert member attached to the voice coil former; and
a cone received by the insert member to provide a flexible coupling between the voice coil former and the cone.

10. The loudspeaker transducer of claim 9, wherein the cone includes a neck portion which is received by the insert member.

11. The loudspeaker transducer of claim 9, wherein the insert member extends beyond the voice coil former.

12. The loudspeaker transducer of claim 9, wherein the insert member is attached to an exterior surface of the voice coil former.

13. The loudspeaker transducer of claim 9, wherein the insert member is attached to an interior surface of the voice coil former.

14. The loudspeaker transducer of claim 9, wherein the insert member is constructed from a material having a durometer value below about 90 Shore A.

15. The loudspeaker transducer of claim 9, wherein a flexible adhesive material is used to secure the insert member to the voice coil former.

16. The loudspeaker of claim 9, wherein a flexible adhesive material is used to secure the cone to the insert member.

17. A loudspeaker transducer comprising:
a voice coil former;
an insert member attached to the voice coil former;
an upper ring and a lower ring each engaging the insert member;
a cone received between the upper and lower rings; and
flexible disks disposed on either side of the cone adjacent the upper and lower rings, wherein the upper and lower rings secure the cone between the disks to provide a flexible coupling between the voice coil former and the cone.

18. The loudspeaker transducer of claim 17, wherein the insert member, the lower ring, and the upper ring are each threaded, and rotation of the upper ring and the lower ring toward one another about the insert member clamps the cone between the upper and lower rings.

19. The loudspeaker transducer of claim 17, further comprising a spider secured to the voice coil former by the lower ring.

20. The loudspeaker transducer of claim 17, wherein the flexible disks have a durometer value below about 90 Shore A.
